(19) United States
(12) Patent Application Publication
(10) Pub. No.: US 2017/0101028 A1
(43) Pub. Date: Apr. 13, 2017

(54) ELECTRICAL SOURCE CONTROL APPARATUS

(71) Applicant: TOYOTA JIDOSHA KABUSHIKI KAISHA, Toyota-shi, Aichi-ken (JP)

(72) Inventors: Makoto HIRAI, Suntou-gun, Shizuoka-ken (JP); Toru ANDO, Obu-shi, Aichi-ken (JP)

(73) Assignee: TOYOTA JIDOSHA KABUSHIKI KAISHA, Toyota-shi, Aichi-ken (JP)

(21) Appl. No.: 15/128,633

(22) PCT Filed: Mar. 5, 2015
(86) PCT No.: PCT/JP2015/057223

§ 371 Date: Sep. 23, 2016

(30) Foreign Application Priority Data
Mar. 27, 2014 (JP) 2014-066579

(51) Int. Cl. B60L 11/18; H02P 27/06; H02J 7/00; H02M 3/158

(52) U.S. Cl. CPC B60L 11/1868; B60L 11/1803; B60L 11/1864; H02M 3/158; H02P 27/06; H02J 7/0026; B60L 2210/40; H02J 7/345

(57) ABSTRACT

An electrical source control apparatus controls an electrical source system having an electrical power converter. The electrical power converter changes an operation mode between a first mode in which the electrical power conversion is performed with electricity storage apparatuses being electrically connected in series and a second mode in which the electrical power conversion is performed with the electricity storage apparatuses being electrically connected in parallel. The electrical source control apparatus has: a first changing device which changes an electrical power limiting value representing an allowable electrical power which can be inputted to or outputted from the electrical source system from the second limiting value to the first limiting value; and a second changing device which changes the operation mode from the second mode to the first mode after the electrical power limiting value is changed to the first limiting value.

### TECHNICAL FIELD

The present invention relates to an electrical source control apparatus which is configured to control an electrical source system having an electrical power converter, wherein the electrical power converter is configured to perform an electrical power conversion with an electricity storage apparatus, for example.

### BACKGROUND ART

An electrical power converter, which is configured to perform an electrical power conversion with an electricity storage apparatus such as a secondary battery, a capacitor and the like by changing a switching state of a switching element, is known. Especially, as disclosed in a Patent Literature 1, an electrical power converter which is configured to simultaneously perform the electrical power conversion with a plurality of electricity storage apparatuses is proposed recently. Especially, the electrical power converter which is disclosed in the Patent Literature 1 is capable of changing an operation mode thereof between a first mode (for example, a series connection mode) and a second mode (for example, a parallel connection mode), wherein the first mode is an operation mode in which the electrical power converter performs the electrical power conversion with the plurality of electricity storage apparatuses being electrically connected in series to an electrical source wire which is electrically connected to a load and the second mode is an operation mode in which the electrical power converter performs the electrical power conversion with the plurality of electricity storage apparatuses being electrically connected in parallel to the electrical source wire. Namely, the operation mode of the electrical power converter which is disclosed in the Patent Literature 1 is changed between (among) a plurality of operation modes by each of which the electrical power conversion between the plurality of electricity storage apparatuses and the electrical source wire is performed in a different manner.

In addition, a Patent Literature 2 is presented as a background art document relating to the electrical power converter which is configured to perform the electrical power conversion with the plurality of electricity storage apparatuses while changing the operation mode.

### CITATION LIST

### Patent Literature

[Patent Literature 1] Japanese Patent Application Laid Open No. 2012-070514

[Patent Literature 2] Japanese Patent Application Laid Open No. 2010-057288

### SUMMARY OF INVENTION

### Technical Problem

Each of the Patent Literatures 1 and 2 discloses an example in which the operation mode of the electrical power converter is changed depending on an operating state of the load. However, the Patent Literatures 1 and 2 do not disclose a specific control method which should be performed when the operation mode of the electrical power converter is changed and a specific procedure of the control method. On the other hand, when the operation mode is changed, the manner of the electrical power conversion between the plurality of electricity storage apparatuses and the electrical source wire is also changed. Thus, such a technical problem that the change of the operation mode may cause an over charge or an over discharge of the electricity storage apparatus may arise.

The subject to be solved by the present invention discussed herein includes the above as one example. It is therefore an object of the present invention to provide, for example, an electrical source control apparatus which is capable of appropriately changing the operation mode of the electrically power converter.

### Solution to Problem

<1>

One aspect of an electrical source control apparatus of the present invention is an electrical source control apparatus (40) which is configured to control an electrical source system (30), the electrical source system having: (i) a plurality of electricity storage apparatuses (31, 32); and (ii) an electrical power converter (33), the electrical power converter being configured to perform an electrical power conversion among the plurality of electricity storage apparatuses and an electrical source wire which is electrically connected to a load (10), the electrical power converter being capable of changing an operation mode of the electrical power converter between a first mode and a second mode, wherein the first mode is an operation mode in which the electrical power converter performs the electrical power conversion with the plurality of electricity storage apparatuses being electrically connected in series to the electrical source wire and the second mode is an operation mode in which the electrical power converter performs the electrical power conversion with the plurality of electricity storage apparatuses being electrically connected in parallel to the electrical source wire, the electrical source control apparatus having: a first changing device (40) which is configured to change an electrical power limiting value (W(0)) from a second limiting value (W(p)) to a first limiting value (W(s)), wherein the electrical power limiting value represents at least one of an allowable value of an electrical power which can be inputted to the electrical source system and an allowable value of an electrical power which can be outputted from the electrical source system, the first limiting value is an limiting value which is to be set when the electrical power converter operates in the first mode, and the second limiting value is an limiting value which is to be set when the electrical power converter operates in the second mode; and a second changing device (40) which is configured to change the operation mode of the electrical power converter from the second mode to the first mode after the first changing device changes the electrical power limiting value from the second limiting value to the first limiting value.

One aspect of the electrical source control apparatus of the present invention is capable of controlling the electrical source system (power source system) which has the plurality of electricity storage apparatuses and the electrical power converter. As a result, the electrical power converter is capable of performing the electrical power conversion with the plurality of electricity storage apparatuses, under the control of the electrical source control apparatus.

Especially in one aspect of the present invention, the electrical source control system has the first changing device and the second changing device in order to control the electrical source system which has the plurality of electricity storage apparatuses and the electrical power converter.

The first changing device changes the electrical power limiting value of the electrical source system. Namely, the first changing device changes the electrical power limiting value when the electrical source system is assumed to be single electricity storage apparatus. Especially, the first changing device changes the electrical power limiting value of the electrical source system from the second limiting value, which is to be set when the electrical power converter operates in the second mode, to the first limiting value, which is to be set when the electrical power converter operates in the first mode.

Incidentally, the electrical power limiting value is a parameter which represents at least one of the allowable value of the electrical power (namely, an allowable inputted electrical power) which can be inputted to the electrical source system and the allowable value of the electrical power (namely, an allowable outputted electrical power) which can be outputted from the electrical source system. A parameter which is referred to as a “Win” is one example of the electrical power limiting value which represents the allowable value of the electrical power which can be inputted to the electrical source system. A parameter which is referred to as a “Wout” is one example of the electrical power limiting value which represents the allowable value of the electrical power which can be outputted from the electrical source system. The electrical source system is controlled such that the electrical power which is inputted to the electrical source system is within an allowable range of the electrical power limiting value (for example, the inputted electrical power is smaller than the electrical power limiting value). Similarly, the electrical source system is controlled such that the electrical power which is outputted from the electrical source system is within an allowable range of the electrical power limiting value (for example, the outputted electrical power is smaller than the electrical power limiting value).

The second changing device changes the operation mode of the electrical power converter. For example, the second changing device changes the operation mode of the electrical power converter from the second mode to the first mode. In this case, the second changing device changes the operation mode of the electrical power converter from the second mode to the first mode after the first changing device changes the electrical power limiting value from the second limiting value to the first limiting value. Namely, it is preferable that the second changing device do not change the operation mode of the electrical power converter from the second mode to the first mode before the first changing device changes the electrical power limiting value from the second limiting value to the first limiting value. In other words, the first changing device changes the electrical power limiting value from the second limiting value to the first limiting value before the second changing device changes the operation mode of the electrical power converter from the second mode to the first mode

The above described aspect of the electrical source control apparatus of the present invention is capable of appropriately changing the operation mode of the electrical power converter. Especially, the above described aspect of the electrical source control apparatus of the present invention is capable of preventing an over charge or an over discharge of the plurality of electricity storage apparatuses when the operation mode of the electrical power converter is changed from the second mode to the first mode. Its technical reason will be explained below.

Firstly, the electrical power converter is capable of individually or separately controlling electrical currents which flow into or flow out from the plurality of electricity storage apparatuses respectively, when the operating mode of the electrical power converter is the second mode. Thus, the electrical power converter is capable of controlling an electrical power distribution ratio such that the electrical power distribution ratio (namely, a ratio of the electrical powers which are inputted to or outputted from the plurality of electricity storage apparatuses respectively) becomes an appropriate distribution ratio, under the control of a below described distribution controlling device. On the other hand, all of the electrical currents which flow into or flow out from the plurality of electricity storage apparatuses respectively are same to each other, when the operating mode of the electrical power converter is the first mode. Thus, the electrical power distribution ratio between the plurality of electricity storage apparatuses is same as a ratio of electrical voltages (typically, electrical voltages between the terminals or nominal electrical voltages) of the plurality of electricity storage apparatuses. Namely, the electrical power converter is not capable of controlling the electrical power distribution ratio between the plurality of electricity storage apparatuses such that the electrical power distribution ratio becomes the appropriate distribution ratio, under the control of a below described distribution controlling device. When the electrical power converter is not capable of controlling the electrical power distribution ratio between the plurality of electricity storage apparatuses, it is also difficult for the electrical power converter to control the electrical power distribution ratio between the plurality of electricity storage apparatuses such that the electrical power which is inputted to or outputted from each electricity storage apparatus is within the allowable range of the electrical power limiting value of each electricity storage apparatus. Thus, it is preferable that the electrical power limiting value of the electrical source system become stricter (typically, an absolute value of the electrical power limiting value become smaller), when the operation mode of the electrical power converter is the first mode, because the electrical power converter is not capable of controlling the electrical power distribution ratio between the plurality of electricity storage apparatuses. Specifically, it is preferable that the first limiting value which is to be set when the operation mode of the electrical power converter is the first mode be stricter than the second limiting value which is to be set when the operation mode of the electrical power converter is the second mode. Typically, it is preferable that the absolute value of the first limiting value which is to be set when the operation mode of the electrical power converter is the first mode be smaller than the absolute value of the second limiting value which is to be set when the operation mode of the electrical power converter is the second mode.

In this condition, if the operation mode of the electrical power converter is changed from the second mode to the first mode before the electrical power limiting value is changed from the second limiting value to the first limiting value, the over charge or the over discharge of at least one of the plurality of electricity storage apparatuses may arise, because the electrical power limiting value remains in the second limiting value, which is not relatively strict, at the timing when the operation mode of the electrical power converter is changed from the second mode to the first mode and thus the relatively large electrical power may be inputted to or outputted from each electricity storage apparatus. The over charge or the over discharge may cause a deterioration of at least one of the plurality of electricity storage apparatuses and a variation of an output of the load.

On the other hand, in one aspect of the present invention, the first changing device changes the electrical power limiting value from the second limiting value to the first limiting value before the operation mode of the electrical power converter is changed from the second mode to the first mode. As a result, an actual electrical power which is actually inputted to or actually outputted from the electrical source system is likely within the allowable range of the first limiting value, before the operation mode of the electrical power converter is changed from the second mode to the first mode. Thus, the over charge or the over discharge of the plurality of electricity storage apparatuses does not likely arise, when the operation mode of the electrical power converter is changed from the second mode to the first mode after the change of the electrical power limiting value. As described above, one aspect of the electrical source control apparatus of the present invention is capable of appropriately changing the operation mode of the electrical power converter.

Incidentally, it is preferable that the first limiting value be an electrical power limiting value which is capable of realizing that the electrical power which is inputted to or outputted from each electricity storage apparatus is within the allowable range of each electricity storage apparatus when the electrical power which is inputted to or outputted from the electrical source system is within the allowable range of the first limiting value.

<2>

In another aspect of the above described electrical source control apparatus (40) of the present invention, the second changing device (40) is configured to change the operation mode of the electrical power converter (33) from the second mode to the first mode, when an actual electrical power (P(0)) which is actually inputted to or actually outputted from the electrical source system (30) is within an allowable range of the first limiting value (W(s)) after the first changing device (40) changes the electrical power limiting value (W(0)) from the second limiting value (W(p)) to the first limiting value (W(s)).

According to this aspect, the electrical power which is actually inputted to or actually outputted from the electrical source system is within the allowable range of the first limiting value, before the operation mode of the electrical power converter is changed from the second mode to the first mode. Thus, the over charge or the over discharge of the plurality of electricity storage apparatuses does not likely arise, when the operation mode of the electrical power converter is changed from the second mode to the first mode after the change of the electrical power limiting value.

<3>

In another aspect of the above described electrical source control apparatus (40), the electrical source control apparatus further has a determining device (40) which is configured to determine whether or not the operation mode of the electrical power converter (33) is to be changed, wherein the first changing device (40) is configured to change the electrical power limiting value (W(0)) from the second limiting value (W(p)) to the first limiting value (W(s)) when the determining device (40) determines that the operation mode of the electrical power converter is to be changed from the second mode to the first mode.

According to this aspect, the actual electrical power which is actually inputted to or actually outputted from the electrical source system is likely within the allowable range of the first limiting value which is typically stricter than the second limiting value, before the operation mode of the electrical power converter is changed from the second mode to the first mode. Thus, the over charge or the over discharge of the plurality of electricity storage apparatuses does not likely arise, when the operation mode of the electrical power converter is changed from the second mode to the first mode after the change of the electrical power limiting value.

<4>

In another aspect of the above described electrical source control apparatus (40), the electrical source control apparatus further has a distribution controlling device (40) which is configured to control an electrical power distribution ratio (r(0)) between the plurality of electricity storage apparatuses (31, 32), wherein the first changing device (40) is configured to change the electrical power limiting value (W(0)) from the second limiting value (W(p)) to the first limiting value (W(s)) after the distribution controlling device controls the electrical power distribution ratio such that the electrical power distribution ratio becomes a first distribution ratio (r(s) which is to be set when the electrical power converter operates in the first mode.

According to this aspect, the distribution controlling device controls the electrical power distribution ratio before the first changing device changes the electrical power limiting value from the second limiting value to the first limiting value. Here, as described above, it is preferable that the first liming value which is to be set when the operating mode of the electrical power converter is the first mode be stricter than the second liming value which is to be set when the operating mode of the electrical power converter is the second mode (typically, the absolute value of the first limiting value be smaller than the absolute value of the second limiting value). Thus, according to this aspect, the distribution controlling device is capable of changing the electrical power distribution ratio before the first limiting value which is relatively strict is used as the electrical power limiting value. Namely, the distribution controlling device is capable of changing the electrical power distribution ratio while the second limiting value which is not relatively strict is used as the electrical power limiting value. Therefore, the distribution controlling device is capable of controlling the electrical power distribution ratio under the non-strict condition.

In addition, the distribution controlling device is capable of controlling the electrical power distribution ratio before the second changing device changes the operation mode of the electrical power converter from the second mode to the first mode, because the distribution controlling device is capable of controlling the electrical power distribution ratio before the first changing device changes the electrical power limiting value from the second limiting value to the first limiting value. Here, as described above, the electrical power distribution ratio between the plurality of electricity storage apparatuses is fixed to the ratio of the electrical voltages of the plurality of electricity storage apparatuses, when the operation mode of the electrical power converter is the first mode. Thus, the electrical power which is inputted to or outputted from each electricity storage apparatus may significantly vary around the time of the change of the operation mode, when the distribution controlling device does not control the electrical power distribution ratio before the second changing device changes the operation mode of the electrical power converter from the second mode to the first mode. However, according to this aspect, the variation of the electrical power which is inputted to or outputted from each electricity storage apparatus, which is caused by the change of the operation mode of the electrical power converter from the second mode to the first mode, is appropriately prevented.

<5>

In another aspect of the above described electrical source control apparatus (40), the second changing device (40) is configured to further change the operation mode of the electrical power converter (33) from the first mode to the second mode, the first changing device (40) is configured to change the electrical power limiting value (W(0)) from the first limiting value (W(s)) to the second limiting value (W(p)) after the second changing device (40) changes the operation mode of the electrical power converter from the first mode to the second mode.

According to this aspect, when the operation mode of the electrical power converter is changed from the first mode to the second mode, the first changing device changes the electrical power limiting value from the first limiting value to the second limiting value after the second changing device changes the operation mode of the electrical power converter from the first mode to the second mode. Namely, the first changing device does not need to change the electrical power limiting value from the first limiting value to the second limiting value before the second changing device changes the operation mode of the electrical power converter from the first mode to the second mode. Thus, as explained in the below described embodiment, the electrical source control apparatus is capable of preventing the over charge or the over discharge of the plurality of electricity storage apparatuses when the operation mode of the electrical power converter is changed from the first mode to the second mode. Therefore, the electrical source control apparatus is capable of appropriately changing the operation mode of the electrical power converter.

<6>

In another aspect of the above described electrical source control apparatus (40) which is configured to change the electrical power limiting value (W(0)) from the first limiting value (W(s)) to the second limiting value (W(p)) after changing the operation mode of the electrical power converter (33) from the first mode to the second mode, the electrical source control apparatus further has a determining device (40) which is configured to determine whether or not the operation mode of the electrical power converter is to be changed, wherein the second changing device (40) is configured to change the operation mode of the electrical power converter from the first mode to the second mode when the determining device determines that the operation mode of the electrical power converter is to be changed from the first mode to the second mode.

According to this aspect, as described above, the over charge or the over discharge of the plurality of electricity storage apparatuses is prevented.

<7>

In another aspect of the above described electrical source control apparatus (40) which is configured to change the electrical power limiting value (W(0)) from the first limiting value (W(s)) to the second limiting value (W(p)) after changing the operation mode of the electrical power converter (33) from the first mode to the second mode, the electrical source control apparatus further has a distribution controlling device (40) which is configured to control an electrical power distribution ratio (r(0)) between the plurality of electricity storage apparatuses (31, 32), wherein the distribution controlling device is configured to control the electrical power distribution ratio such that the electrical power distribution ratio becomes a second distribution ratio (r(p)) which is to be set when the electrical power converter operates in the second mode after the first changing device (40) changes the electrical power limiting value from the first limiting value to the second limiting value.

According to this aspect, the distribution controlling device controls the electrical power distribution ratio after the first changing device changes the electrical power limiting value from the first limiting value to the second limiting value. Here, as described above, it is preferable that the first liming value which is to be set when the operating mode of the electrical power converter is the first mode be stricter than the second liming value which is to be set when the operating mode of the electrical power converter is the second mode (typically, the absolute value of the first limiting value be smaller than the absolute value of the second limiting value). Thus, according to this aspect, the distribution controlling device is capable of changing the electrical power distribution ratio after not the first limiting value which is relatively strict but the second limiting value which is not relatively strict is set as the electrical power limiting value. Namely, the distribution controlling device is capable of changing the electrical power distribution ratio while the second limiting value which is not relatively strict is set as the electrical power limiting value. Therefore, the distribution controlling device is capable of controlling the electrical power distribution ratio under the non-strict condition.

The operation and other advantages of the present invention will become more apparent from embodiments explained below.

### BRIEF DESCRIPTION OF DRAWINGS

FIG. 1 is a block diagram illustrating a structure of a vehicle of a present embodiment.

FIG. 2 is a circuit diagram illustrating a circuit structure of an electrical power converter.

FIG. 3(a) and FIG. 3(b) are circuit diagrams illustrating an electrical current path via a first electrical source in the electrical power converter which operates in a parallel mode.

FIG. 4(a) and FIG. 4(b) are circuit diagrams illustrating an electrical current path via a second electrical source in the electrical power converter which operates in the parallel mode.

FIG. 5(a) and FIG. 5(b) are circuit diagrams illustrating an electrical current path in the electrical power converter which operates in a series mode.

FIG. 6 is a flowchart illustrating a flow of a mode changing operation to change an operation, which is one of operations of the electrical power converter.

FIG. 7 is a timing chart illustrating a system electrical power, a first electrical power, a second electrical power, a system electrical power limiting value and the operation mode of the electrical power converter when the mode changing operation to change the operation mode of the electrical power converter from the parallel mode to the series mode is performed.

FIG. 8 is a timing chart illustrating the system electrical power, the first electrical power, the second electrical power, the system electrical power limiting value and the operation mode of the electrical power converter when the mode changing operation to change the operation mode of the electrical power converter from the series mode to the parallel mode is performed.

### DESCRIPTION OF EMBODIMENTS

Next, an embodiment of the electrical source control apparatus of the present invention will be explained. Incidentally, in the following explanation, an embodiment in which the electrical source control apparatus of the present invention is adapted to a vehicle (especially, a vehicle which moves (drives) by using an electrical power outputted from the electricity storage apparatus) is used as one example for the explanation. However, the electrical source control apparatus may be adapted to any equipment other than the vehicle.

(1) Structure of Vehicle 1

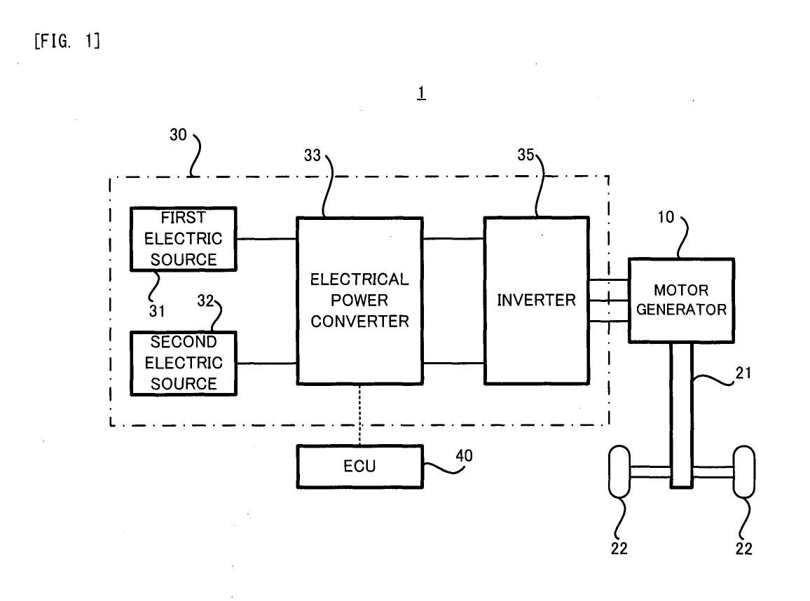

Firstly, with reference to FIG. 1, the structure of the vehicle 1 of the present embodiment will be explained. FIG. 1 is a block diagram illustrating the structure of the vehicle 1 of the present embodiment.

As illustrated in FIG. 1, the vehicle 1 has a motor generator 10 which is one example of the “load”, an axle shaft 21, wheels 22, an electrical source system 30 and an ECU 40 which is one example of the “electrical source control apparatus”.

The motor generator 10 operates by using an electrical power outputted from the electrical source system 30 when the vehicle 1 is in a power running state. Thus, the motor generator 10 mainly functions as a motor for supplying a power (namely, a power which is required for the vehicle 1 to move) to the axle shaft 21. The power which is transmitted to the axle shaft 21 becomes a power to making the vehicle 1 move via the wheels 22. Furthermore, the motor generator mainly functions as a generator for charging a first electrical source 31 and a second electrical source 32 of the electrical source system 30 when the vehicle 1 is in a regeneration state.

Incidentally, the vehicle 1 may have two or more motor generators 10. Furthermore, the vehicle 1 may have an engine in addition to the motor generator 10.

The electrical source system 30 outputs the electrical power, which is required for the motor generator 10 to function as the motor, to the motor generator 10, when the vehicle 1 is in the power running state. Furthermore, the electrical power which is generated by the motor generator 10 functioning as the generator is inputted from the motor generator 10 to the electrical source system 30, when the vehicle 1 is in the regeneration state.

The electrical source system 30 has the first electrical source 31 which is one example of the “electricity storage apparatus”, the second electrical source 32 which is one example of the “electricity storage apparatus”, an electrical power converter 33 and an inverter 35.

Each of the first electrical source 31 and the second electrical source 32 is an electrical source which is capable of outputting the electrical power (namely, discharging). Each of the first electrical source 31 and the second electrical source 32 may be an electrical source to which the electrical power can be inputted (namely, which can be charged), in addition to be capable of outputting the electrical power. At least one of the first electrical source 31 and the second electrical source 32 may be a lead battery, a lithium-ion battery, a nickel-hydrogen battery, a fuel battery, an electrical double layer capacitor or the like, for example.

The electrical power converter 33 converts the electrical power which is outputted from the first electrical source 31 and the electrical power which is outputted from the second electrical source 32 depending on a required electrical power which is required for the electrical source system 30 (in this case, the required electrical power is typically an electrical power which the electrical source system 30 should output to the motor generator 10, for example), under the control of the ECU 40. The electrical power converter 33 outputs the converted electrical power to the inverter 35. Furthermore, the electrical power converter 33 converts the electrical power which is inputted from the inverter 35 (namely, the electrical power which is generated by the regeneration of the motor generator 10) depending on the required electrical power which is required for the electrical source system 30 (in this case, the required electrical power is typically an electrical power which should be inputted to the electrical source system 30, and the required electrical power is substantially an electrical power which should be inputted to the first electrical source 31 and the second electrical source 32, for example), under the control of the ECU 40. The electrical power converter 33 outputs the converted electrical power to at least one of the first electrical source 31 and the second electrical source 32. The above described electrical power conversion allows the electrical power converter 33 to distribute the electrical power among the first electrical source 31, the second electrical source 32 and the inverter 35.

The inverter 35 converts the electrical power (DC (direct current) electrical power), which is outputted from the electrical power converter 33, to an AC (alternating current) electrical power, when the vehicle 1 is in the power running state. Then, the inverter 35 supplies the electrical power, which is converted to the AC electrical power, to the motor generator 10. Furthermore, the inverter 35 converts the electrical power (AC electrical power), which is generated by the motor generator 10, to the DC electrical power. Then, the inverter 35 supplies the electrical power, which is converted to the DC electrical power, to the electrical power converter 33.

The ECU 40 is an electrical controlling unit which is configured to control the whole of the operation of the vehicle 1. Especially in the present embodiment, the ECU 40 is capable of controlling the whole of the operation of the electrical source system 30.

(2) Circuit Structure of Electrical Power Converter 33

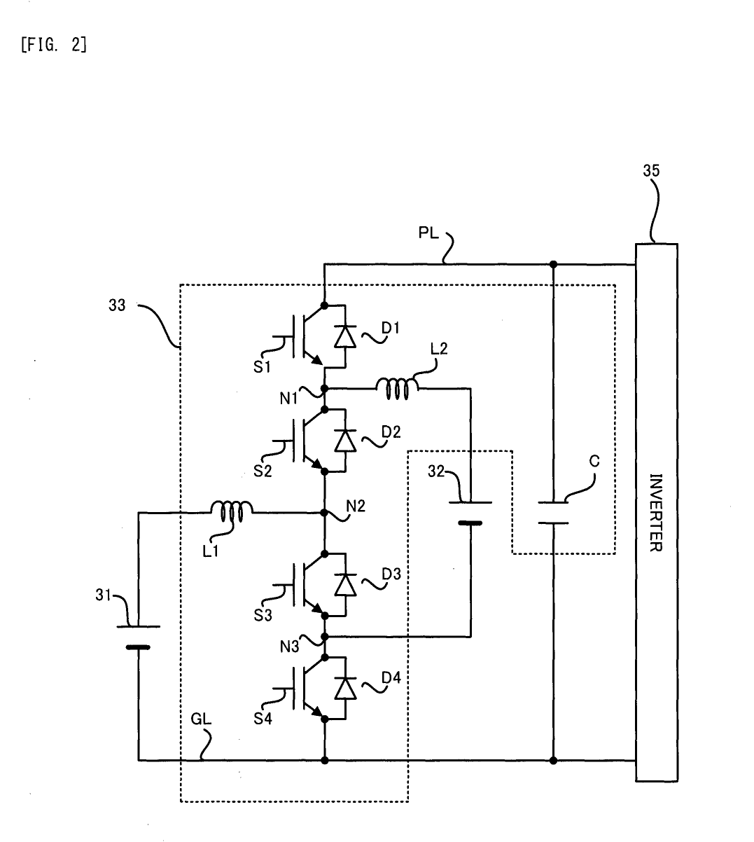

Next, with reference to FIG. 2, the circuit structure of the electrical power converter 33 will be explained. FIG. 2 is a circuit diagram illustrating the circuit structure of the electrical power converter 33.

As illustrated in FIG. 2, the electrical power converter 33 has a switching element S1, a switching element S2, a switching element S3, a switching element S4, a diode D1, a diode D2, a diode D3, a diode D4, a reactor L1, a reactor L2 and a smoothing capacitor C.

The switching element S1 is capable of changing a switching state thereof depending on a control signal which is supplied from the ECU 40. Namely, the switching element S1 is capable of changing the switching state thereof from an ON state to an OFF state or from the OFF state to the ON state. An IGBT (Insulated Gate Bipolar Transistor), a MOS (Metal Oxide Semiconductor) transistor for the electrical power or a bipolar transistor for the electrical power may be used as the switching element S1. The above explanation on the switching element S1 can be applied to the remaining switching elements S2 to S4.

The switching elements S1 to S4 are electrically connected in series between an electrical source line PL and a ground line GL, wherein the electrical source line PL and the ground line GL are electrically connected to the motor generator 10 via the inverter 35. Specifically, the switching element S1 is electrically connected between the electrical source line PL and a node N1. The switching element S2 is electrically connected between the node N1 and a node N2. The switching element S3 is electrically connected between the node N2 and a node N3. The switching element S4 is electrically connected between the node N3 and the ground line GL.

The diode D1 is electrically connected in parallel to the switching element S1. The diode D2 is electrically connected in parallel to the switching element S2. The diode D3 is electrically connected in parallel to the switching element S3. The diode D4 is electrically connected in parallel to the switching element S4. Incidentally, the diode D1 is connected in an inverse-parallel manner to the switching element S1. Same argument can be applied to the remaining diodes D2 to D4.

The reactor L1 is electrically connected between a positive terminal of the first electrical source 31 and the node N2. The reactor L2 is electrically connected between a positive terminal of the second electrical source 32 and the node N1. The smoothing capacitor C is electrically connected between the electrical source line PL and the ground line GL. A negative terminal of the first electrical source 31 is electrically connected to the ground line GL. A negative terminal of the second electrical source 32 is electrically connected to the node N3. The inverter 35 is electrically connected between the electrical source line PL and the ground line GL.

The electrical power converter 33 typically functions as a boost chopper circuit for either one or both of the first electrical source 31 and the second electrical source 32, when the vehicle 1 is in the power running state. On the other hand, the electrical power converter 33 typically functions as a step-down chopper circuit for either one or both of the first electrical source 31 and the second electrical source 32, when the vehicle 1 is in the regeneration state. As a result, the electrical power converter 33 is capable of performing the electrical power conversion with either one or both of the first electrical source 31 and the second electrical source 32. Incidentally, an operation of the electrical power converter 33, which is capable of performing the electrical power conversion with either one or both of the first electrical source 31 and the second electrical source 32, will be explained later.

Incidentally, the fluctuation of the voltage between the electrical source line PL and the ground line GL, which is caused by the change of the switching states of the switching elements S1 to D4, is suppressed by the smoothing capacitor C.

(3) Operation of Electrical Power Converter 33

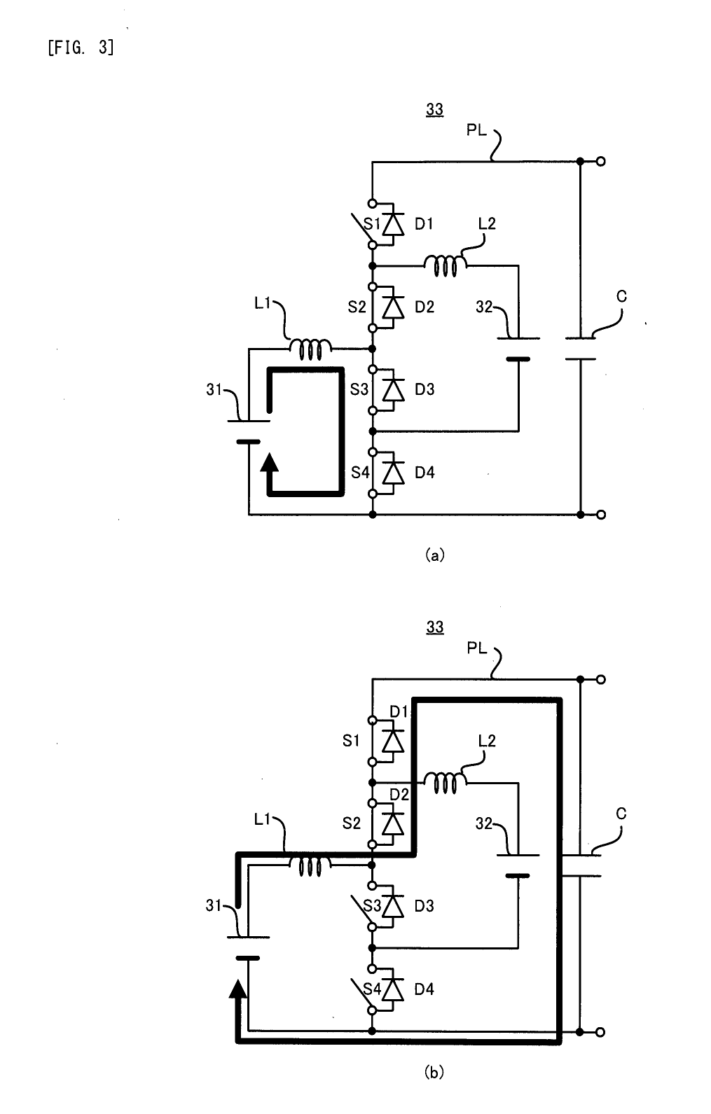

Next, with reference to FIG. 3 to FIG. 8, the operation of the electrical power converter 33 will be explained.

(3-1) Operation Mode of Electrical Power Converter 33

Firstly, with reference to FIG. 3 to FIG. 5, the operation mode of the electrical power converter 33 will be explained as a premise of the operation of the electrical power converter 33.

(3-1-1) Parallel Mode

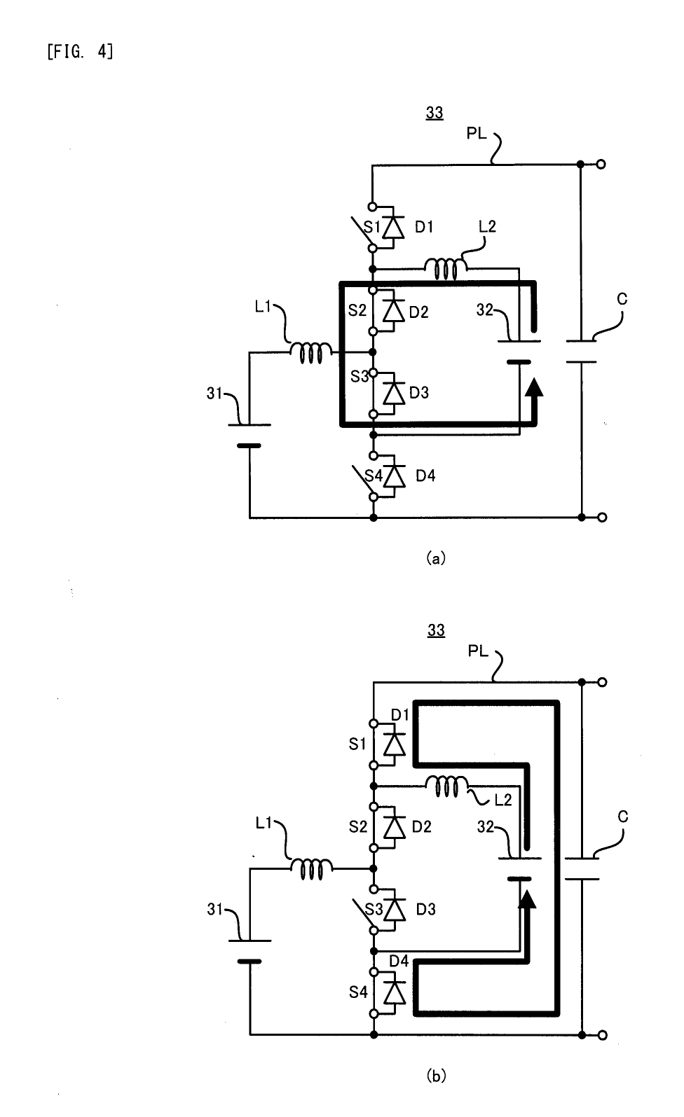

Firstly, with reference to FIG. 3(a) and FIG. 3(b) and FIG. 4(a) and FIG. 4(b), the parallel mode, which is one example of the “second mode”, among the operation modes of the electrical power converter 33 will be explained. Each of FIG. 3(a) and FIG. 3(b) is a circuit diagram illustrating an electrical current path via the first electrical source 31 in the electrical power converter 33 which operates in the parallel mode. Each of FIG. 4(a) and FIG. 4(b) is a circuit diagram illustrating an electrical current path via the second electrical source 32 in the electrical power converter 33 which operates in the parallel mode.

The parallel mode is an operation mode in which the electrical power conversion is performed in such a condition that the first electrical source 31 and the second electrical source 32 are electrically connected in parallel between the electrical source line PL and the ground line GL. The electrical power converter 33 is capable of operating in the parallel mode by keeping the switching state of the switching element S2 or S4 in the ON state under the control of the ECU 40.

For example, the ECU 40 controls the electrical power converter 33 to keep the switching state of the switching element S2 in the ON state, when an electrical voltage (typically, an electrical voltage between the positive and negative terminals or a nominal electrical voltage) V(1) of the first electrical source 31 is larger than an electrical voltage (typically, an electrical voltage between the positive and negative terminals or a nominal electrical voltage) V(2) of the second electrical source 32. In this case, the first electrical source 31 and the second electrical source 32 are electrically connected in parallel via the switching elements S3 and S4. As a result, the electrical power converter 33 is capable of operating in the parallel mode.

When the switching state of the switching element S2 is kept in the ON state, the electrical power converter 33 changes the switching states of the switching elements S3 and S4, which are a lower arm for the first electrical source 31, between the ON state and the OFF state, in order to function as the boost chopper circuit for the first electrical source 31. For example, as illustrated in FIG. 3(a), the electrical power which is outputted from the first electrical source 31 is stored in the reactor L1 during a period in which the switching elements S3 and S4 are in the ON state. On the other hand, as illustrated in FIG. 3(b), the electrical power which is stored in the reactor L1 is supplied to the electrical source line PL during a period in which at least one of the switching elements S3 and S4 is in the OFF state. Incidentally, it is preferable that the switching state of the switching element S1, which is an upper arm for the first electrical source 31, is inverse (namely, complemented) to the switching state of at least one of the switching elements S3 and S4.

Moreover, the electrical power converter 33 changes the switching state of the switching element S1, which is the upper arm for the first electrical source 31, between the ON state and the OFF state, in order to function as the step-down chopper circuit for the first electrical source 31, although there is no illustration in the drawings for the purpose of the simple explanation. For example, the electrical power which is generated by the regeneration is stored in the reactor L1 during a period in which the switching element S1 is in the ON state. On the other hand, the electrical power which is stored in the reactor L1 is supplied to the ground line GL during a period in which the switching element S1 is in the OFF state. Incidentally, it is preferable that the switching state of at least one of the switching elements S3 and S4, which are the lower arm for the first electrical source 31, is inverse to the switching state of the switching element S1.

On the other hand, the electrical power converter 33 changes the switching state of the switching element S3, which is the lower arm for the second electrical source 32, between the ON state and the OFF state, in order to function as the boost chopper circuit for the second electrical source 32. For example, as illustrated in FIG. 4(a), the electrical power which is outputted from the second electrical source 32 is stored in the reactor L2 during a period in which the switching element S3 is in the ON state. On the other hand, as illustrated in FIG. 4(b), the electrical power which is stored in the reactor L2 is supplied to the electrical source line PL during a period in which the switching element S3 is in the OFF state. Incidentally, it is preferable that the switching state of at least one of the switching elements S1 and S4, which are the upper arm for the second electrical source 32, is inverse to the switching state of the switching element S3.

Moreover, the electrical power converter 33 changes the switching states of the switching elements S1 and S4, which are the upper arm for the second electrical source 32, between the ON state and the OFF state, in order to function as the step-down chopper circuit for the second electrical source 32, although there is no illustration in the drawings for the purpose of the simple explanation. For example, the electrical power which is generated by the regeneration is stored in the reactor L2 during a period in which the switching elements S1 and S4 are in the ON state. On the other hand, the electrical power which is stored in the reactor L2 is supplied to a line to which the negative terminal of the second electrical source 32 is connected during a period in which at least one of the switching elements S1 and S4 is in the OFF state. Incidentally, it is preferable that the switching state of the switching element S3, which is the lower arm for the second electrical source 32, is inverse to the switching state of at least one of the switching elements S1 and S4.

On the other hand, the ECU 40 controls the electrical power converter 33 to keep the switching state of the switching element S4 in the ON state, when the electrical voltage V(1) of the first electrical source 31 is smaller than the electrical voltage V(2) of the second electrical source 32. In this case, the first electrical source 31 and the second electrical source 32 are electrically connected in parallel via the switching elements S2 and S3. As a result, the electrical power converter 33 is capable of operating in the parallel mode.

When the switching state of the switching element S4 is kept in the ON state, the electrical power converter 33 changes the switching state of the switching element S3, which is the lower arm for the first electrical source 31, between the ON state and the OFF state, in order to function as the boost chopper circuit for the first electrical source 31. Moreover, the electrical power converter 33 changes the switching states of the switching elements S1 and S2, which are the upper arm for the first electrical source 31, between the ON state and the OFF state, in order to function as the step-down chopper circuit for the first electrical source 31. Furthermore, it is preferable that the switching state of at least one of the switching elements S1 and S2 is inverse to the switching state of the switching element S3.

Moreover, when the switching state of the switching element S4 is kept in the ON state, the electrical power converter 33 changes the switching states of the switching elements S2 and S3, which are the lower arm for the second electrical source 32, between the ON state and the OFF state, in order to function as the boost chopper circuit for the second electrical source 32. Moreover, the electrical power converter 33 changes the switching state of the switching element S1, which is the upper arm for the second electrical source 32, between the ON state and the OFF state, in order to function as the step-down chopper circuit for the second electrical source 32. Furthermore, it is preferable that the switching state of at least one of the switching elements S2 and S3 is inverse to the switching state of the switching element S1.

Incidentally, in the above described explanation, the switching state of the specific switching element is changed between the ON state and the OFF state in the parallel mode, and thus at least one of a boost operation and a step-down operation for at least one of the first electrical source 31 and the second electrical source 32 is performed. However, the switching states of all of the switching elements may be fixed in the parallel mode. Namely, the boost operation and the step-down operation for each of the first electrical source 31 and the second electrical source 32 may not be performed in the parallel mode.

(3-1-2) Series Mode

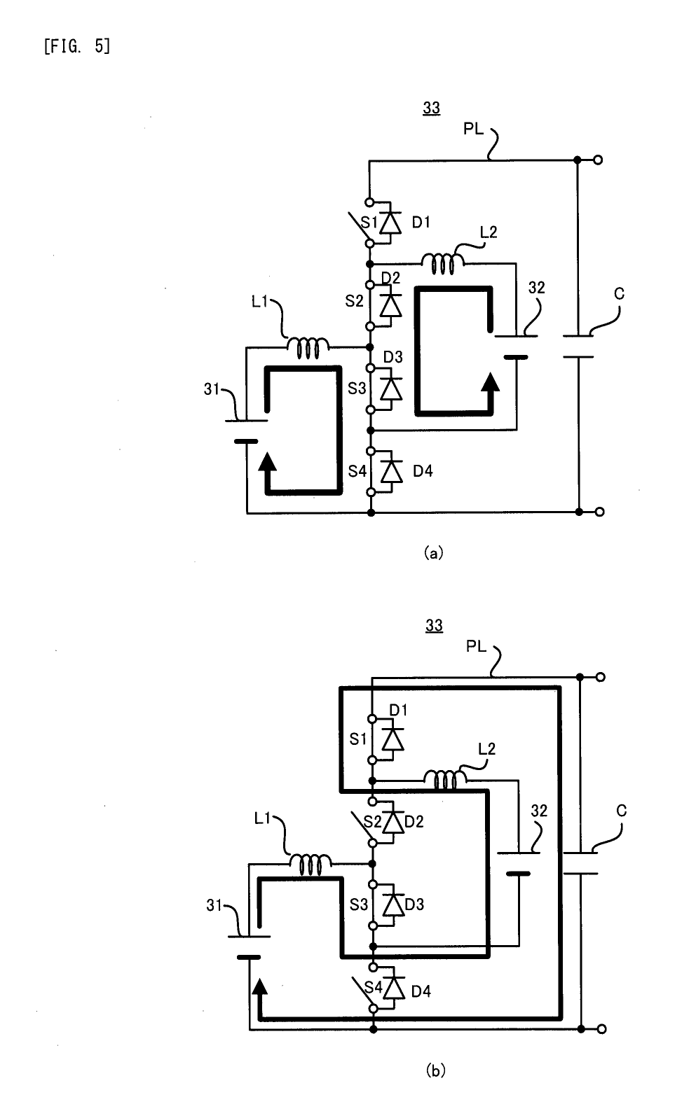

Next, with reference to FIG. 5(a) and FIG. 5(b), the series mode, which is one example of the “first mode”, among the operation modes of the electrical power converter 33 will be explained. Each of FIG. 5(a) and FIG. 5(b) is a circuit diagram illustrating an electrical current path in the electrical power converter 33 which operates in the series mode.

The series mode is an operation mode in which the electrical power conversion is performed in such a condition that the first electrical source 31 and the second electrical source 32 are electrically connected in series between the electrical source line PL and the ground line GL. The electrical power converter 33 is capable of operating in the series mode by keeping the switching state of the switching element S3 in the ON state under the control of the ECU 40.

When the switching state of the switching element S3 is kept in the ON state, the electrical power converter 33 changes the switching states of the switching elements S2 and S4 between the ON state and the OFF state, in order to function as the boost chopper circuit for the first electrical source 31 and the second electrical source 32. Moreover, the electrical power converter 33 changes the switching state of the switching element S1 between the ON state and the OFF state such that the switching state of the switching element S1 is inverse to the switching state of each of the switching elements S2 and S4. For example, as illustrated in FIG. 5(a), the electrical power which is outputted from the first electrical source 31 is stored in the reactor L1 and the electrical power which is outputted from the second electrical source 32 is stored in the reactor L2 during a period in which the switching elements S2 and S4 are in the ON state and the switching element S1 is in the OFF state. On the other hand, as illustrated in FIG. 5(b), the electrical power which is stored in each of the reactors L1 and L2 is supplied to the electrical source line PL during a period in which the switching elements S2 and S4 are in the OFF state and the switching element S1 is in the ON state.

Moreover, the electrical power converter 33 changes the switching state of the switching element S1 between the ON state and the OFF state, in order to function as the step-down chopper circuit for the first electrical source 31 and the second electrical source 32, although there is no illustration in the drawings for the purpose of the simple explanation. Moreover, the electrical power converter 33 changes the switching states of the switching elements S2 and S4 between the ON state and the OFF state such that the switching states of the switching elements S2 and S4 are inverse to the switching state of the switching element S1. For example, the electrical power which is generated by the regeneration is stored in each of the reactors L1 and L2 during a period in which the switching element S1 is in the ON state and the switching elements S2 and S4 are in the OFF state. On the other hand, the electrical power which is stored in each of the reactors L1 and L2 is supplied to the ground line GL during a period in which the switching element S1 is in the OFF state and the switching elements S2 and S4 are in the ON state.

Incidentally, in the above described explanation, the switching state of the specific switching element is changed between the ON state and the OFF state in the series mode, and thus at least one of a boost operation and a step-down operation for at least one of the first electrical source 31 and the second electrical source 32 is performed. However, the switching states of all of the switching elements may be fixed in the series mode. Namely, the boost operation and the step-down operation for each of the first electrical source 31 and the second electrical source 32 may not be performed in the series mode.

The electrical power converter 33 of the present embodiment is capable of changing the operation mode between the above described parallel mode and the above described series mode under the control of the ECU 40. Hereinafter, a mode changing operation to change the operation mode which is one of the operations of the electrical power converter 33 will be explained.

(3-2) Flow of Operation (especially, Mode Changing Operation) of Electrical Power Converter 33

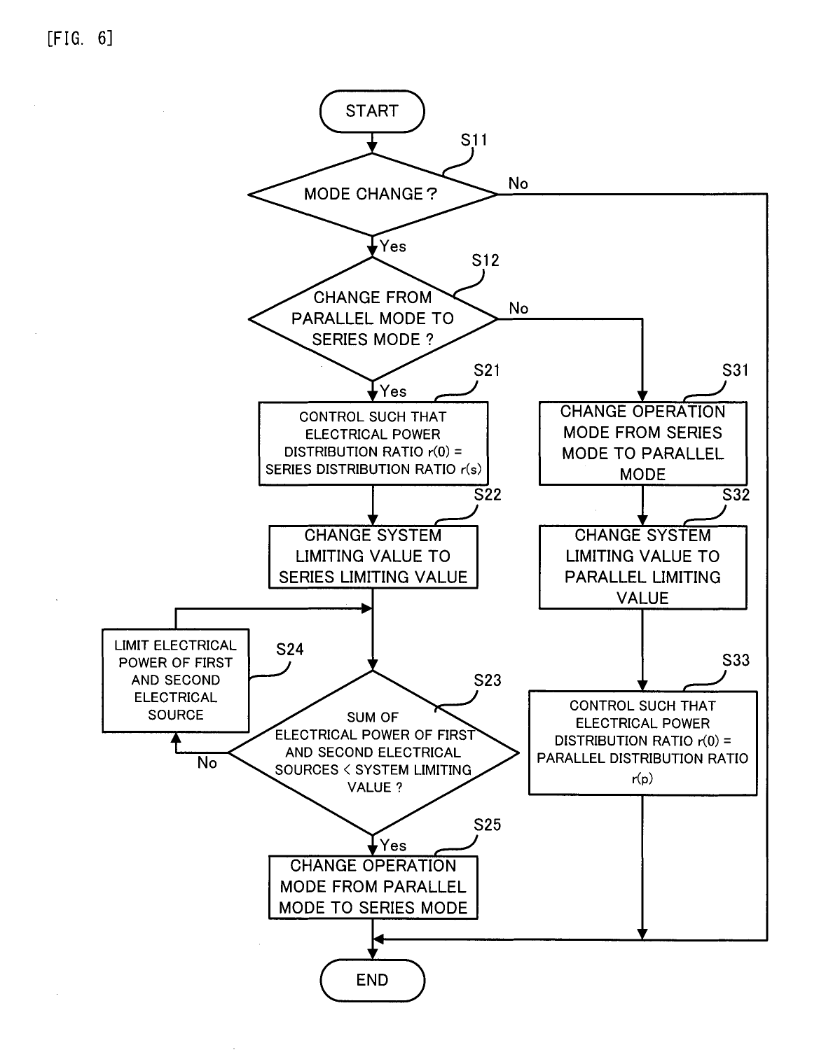

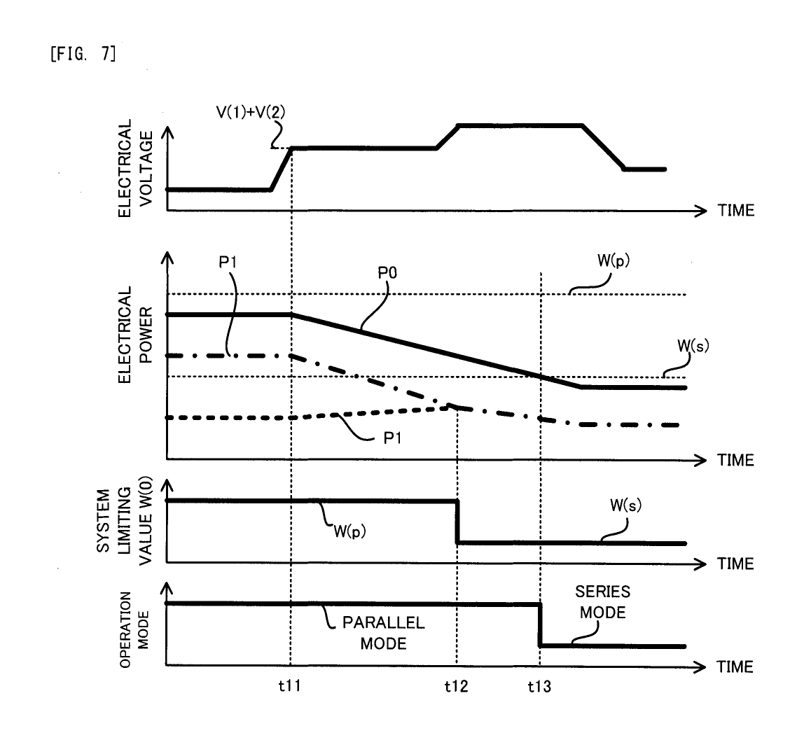

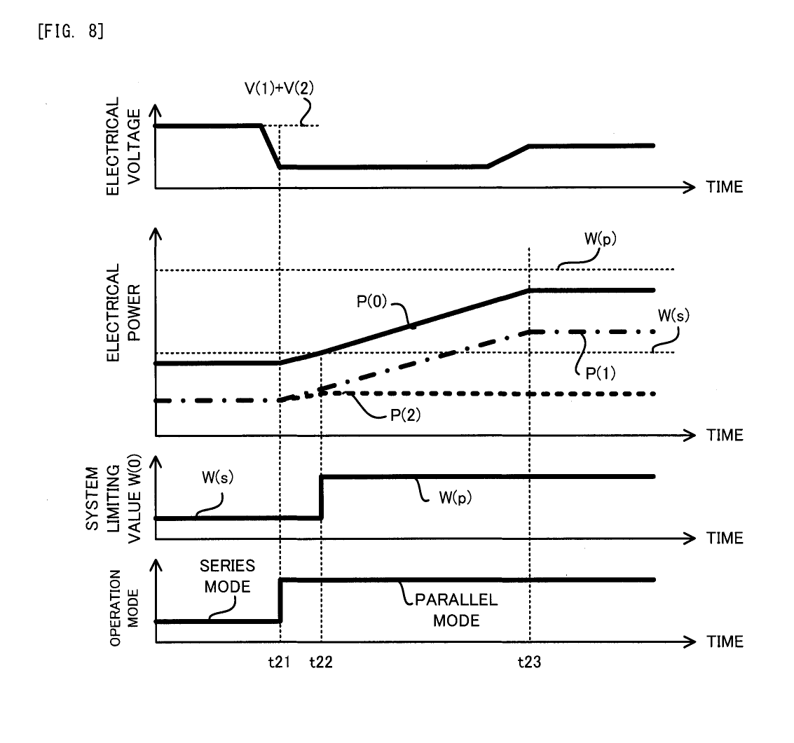

With reference to FIG. 6 to FIG. 8, the mode changing operation to change the operation mode which is one of the operations of the electrical power converter 33 will be explained. FIG. 6 is a flowchart illustrating the flow of the mode changing operation to change the operation mode which is one of the operations of the electrical power converter 33. FIG. 7 is a timing chart illustrating a system electrical power P(0), a first electrical power P(1), a second electrical power P(2), a system electrical power limiting value W(0) and the operation mode of the electrical power converter 33 when the mode changing operation to change the operation mode of the electrical power converter 33 from the parallel mode to the series mode is performed. FIG. 8 is a timing chart illustrating the system electrical power P(0), the first electrical power P(1), the second electrical power P(2), the system electrical power limiting value W(0) and the operation mode of the electrical power converter 33 when the mode changing operation to change the operation mode of the electrical power converter 33 from the series mode to the series mode is performed.

As illustrated in FIG. 6, the ECU 40, which is one example of the “determining device”, determines whether or not the operation mode of the electrical power converter 33 is to be changed (step S11). For example, the ECU 40 judges what the operation mode which is to be set for the electrical power converter 33 is, on the basis of the operation state of the motor generator 10 which is the load and the operation state of each of the first electrical source 31 and the second electrical source 32. The ECU 40 may determine whether or not the operation mode of the electrical power converter 33 is to be changed, by comparing the current operation mode of the electrical power converter 33 with the operation mode which is newly to be set as the operation mode for the electrical power converter 33.

As a result of the determination of the step S11, when it is determined that the operation mode does not need to be changed (step S11: No), the ECU 40 does not need to perform the below described operations from step S12 to step S33.

On the other hand, as a result of the determination of the step S11, when it is determined that the operation mode is to be changed (step S11: Yes), the ECU 40, which is one example of the “determining device”, determines whether or not the operation mode is to be changed from the parallel mode to the series mode (step S12).

As a result of the determination of step S12, when it is determined that the operation mode is to be changed from the parallel mode to the series mode (step S12: Yes), the ECU 40, which is one example of the “distribution controlling device”, controls the electrical power converter 33 such that an electrical power distribution ratio r(0) between the first electrical source 31 and the second electrical source 32 becomes a series distribution ratio r(s) (step S21).

Here, the electrical power distribution ratio r(0) represents a ratio of the electrical power which is outputted from the first electrical source 31 and the electrical power which is outputted from the second electrical source 32, when the vehicle 1 is in the power running state. On the other hand, the electrical power distribution ratio r(0) represents a ratio of the electrical power which is inputted to the first electrical source 31 and the electrical power which is inputted to the second electrical source 32, when the vehicle 1 is in the regeneration state. Hereinafter, at least one of the electrical power which is outputted from the first electrical source 31 and the electrical power which is inputted to the first electrical source 31 is referred to as a “first electrical power P(1)”, for the purpose of the illustration. Moreover, at least one of the electrical power which is outputted from the second electrical source 32 and the electrical power which is inputted to the second electrical source 32 is referred to as a “second electrical power P(2)”, for the purpose of the illustration.

The series distribution ratio r(s) represents a “target value of the electrical power distribution ratio r(0)” which is set when the electrical power converter 33 operates in the series mode. Incidentally, when the electrical power converter 33 operates in the series mode, the electrical power distribution ratio r(0) is same as a ratio of the voltage V(1) of the first electrical source 31 and the voltage V(2) of the second electrical source 32. Therefore, the series distribution ratio r(s) is substantially same as the ratio of the voltage V(1) of the first electrical source 31 and the voltage V(2) of the second electrical source 32.

As a result of the control of step S21, the electrical power distribution ratio r(0)=P(1) P(2) between the first electrical source 31 and the second electrical source 32 becomes to be same as the series distribution ratio r(s)=V(1) V(2). After the electrical power distribution ratio r(0) becomes to be same as the series distribution ratio r(s), the ECU 40, which is one example of the “first changing device”, changes an electrical power limiting value of the whole electrical source system 30 (hereinafter, it is referred to as the “system limiting value”) W(0) to a series limiting value W(s) which is one example of the “first limiting value” (step S22).

Here, the system limiting value W(0) represents an upper limit value Wout(0) of the electrical power which can be outputted from the electrical source system 30, when the vehicle 1 is in the power running state. On the other hand, the system limiting value W(0) represents an upper limit value Win(0) of the electrical power which can be inputted to the electrical source system 30, when the vehicle 1 is in the regeneration state. Namely, the system limiting value W(0) represents the upper limit value of at least one of the electrical power which can be outputted from the electrical source system 30 and the electrical power which can be inputted to the electrical source system 30.

The series limiting value W(s) represents a “target value of the system limiting value W(0)” which is set when the electrical power converter 33 operates in the series mode.

As a result, the ECU 40 controls the electrical power converter 33 such that the electrical power which is outputted from the electrical source system 30 is within an allowable range of the series limiting value W(s), when the vehicle 1 is in the power running state. On the other hand, the ECU 40 controls the electrical power converter 33 such that the electrical power which is inputted to the electrical source system 30 is within an allowable range of the series limiting value W(s), when the vehicle 1 is in the regeneration state. Incidentally, hereinafter, at least one of the electrical power which is outputted from the electrical source system 30 and the electrical power which is inputted to the electrical source system 30 is referred to as a “system electrical power P(0)”, for the purpose of the illustration.

The operation mode of the electrical power converter 33 is not yet changed to the series mode at this timing. Namely, the operation mode of the electrical power converter 33 remains in the parallel mode. Therefore, the system electrical power P(0) is substantially same as a sum of the first electrical power P(1) and the second electrical power P(2).

After the system limiting value W(0) is changed to the series limiting value W(s), the ECU 40 determines whether or not the sum of the first electrical power P(1) and the second electrical power P(2) is equal to or less than the system limiting value W(0) (step S23). Namely, the ECU 40 determines whether or not the system electrical power P(0) is equal to or less than the series limiting value W(s).

As a result of the determination of step S23, when it is determined that the sum of the first electrical power P(1) and the second electrical power P(2) is not equal to or less than the system limiting value W(0) (step S23: No), the ECU 40 continues to control the electrical power converter 33 such that the system electrical power P(0) is within the allowable range of the series limiting value W(s) (step S24). Namely, the ECU 40 continues to control the electrical power converter 33 such that at least one of the first electrical power P(1) and the second electrical power P(2) is limited (step S24). Typically, the ECU 40 continues to control the electrical power converter 33 such that an absolute value of at least one of the first electrical power P(1) and the second electrical power P(2) decreases.

On the other hand, as a result of the determination of step S23, when it is determined that the sum of the first electrical power P(1) and the second electrical power P(2) is equal to or less than the system limiting value W(0) (step S23: Yes), the ECU 40, which is one example of the “second changing device”, changes the operation mode of the electrical power converter 33 from the parallel mode to the series mode (step S25). Namely, the ECU 40 ends the operation of controlling the switching elements S1 to S4 in a manner for the parallel mode and starts the operation of controlling the switching elements S1 to S4 in a manner for the series mode.

The above described mode changing operation for changing the operation mode from the parallel mode to the series mode will be supplementary explained with reference to FIG. 7. As illustrated in FIG. 7, the ECU 40 determines at a time point t11 that the operation mode is to be changed from the parallel mode to the series mode. In this case, the ECU 40 controls the electrical power converter 33 such that the electrical power distribution ratio r(0) becomes the series distribution ratio r(s). As a result, at least one of the first electrical power P(1) and the second electrical power P(2) is changed such that the electrical power distribution ratio r(0) becomes the series distribution ratio r(s). Then, the electrical power distribution ratio r(0) becomes the series distribution ratio r(s) at a time point t12. Incidentally, FIG. 7 illustrates an example in which the series distribution ratio r(s) is 1:1. Therefore, the ECU 40 changes the system limiting value W(0) to the series limiting value W(s) at the time point t12. In this case, the ECU 40 controls the electrical power converter 33 such that the system electrical power P(0) is equal to or less than the series limiting value W(s). As a result, at least one of the first electrical power P(1) and the second electrical power P(2) is changed such that the system electrical power P(0) is equal to or less than the series limiting value W(s). Then, the system electrical power P(0) is equal to or less than the series limiting value W(s) at a time point t13. Therefore, the ECU 40 changes the operation mode of the electrical power converter 33 from the parallel mode to the series mode at the time point t13.

On the other hand, as a result of the determination of step S12, when it is determined that the operation mode is not to be changed from the parallel mode to the series mode (step S12: No), it is assumed that the operation mode is to be changed from the series mode to the parallel mode. In this case, the ECU 40, which is one example of the “second changing device”, changes the operation mode of the electrical power converter 33 from the series mode to the parallel mode (step S31). Namely, the ECU 40 ends the operation of controlling the switching elements S1 to S4 in a manner for the series mode and starts the operation of controlling the switching elements S1 to S4 in a manner for the parallel mode.

After the operation mode of the electrical power converter 33 is changed from the series mode to the parallel mode, the ECU 40, which is one example of the “first changing device”, changes the system limiting value W(0) to a parallel limiting value W(p) which is one example of the “second limiting value” (step S32).

After the system limiting value W(0) is changed to the parallel limiting value W(p), the ECU 40, which is one example of the “distribution controlling device”, controls the electrical power converter 33 such that the electrical power distribution ratio r(0) becomes a parallel distribution ratio r(p) (step S33). Here, the parallel distribution ratio r(p) represents a “target value of the electrical power distribution ratio r(0)” which is set when the electrical power converter 33 operates in the parallel mode.

The above described mode changing operation for changing the operation mode from the series mode to the parallel mode will be supplementary explained with reference to FIG. 8. As illustrated in FIG. 8, the ECU 40 determines at a time point t21 that the operation mode is to be changed from the series mode to the parallel mode. Therefore, the ECU 40 changes the operation mode of the electrical power converter 33 from the series mode to the parallel mode at the time point t21. Then, the ECU 40 changes the system limiting value W(0) to the parallel limiting value W(p) at a time point t22. Then, the ECU 40 controls the electrical power converter 33 such that the electrical power distribution ratio r(0) becomes the parallel distribution ratio r(p) at a time point t23.

Here, the parallel limiting value W(p) represents the “target value of the system limiting value W(0)” which is set when the electrical power converter 33 operates in the parallel mode. Incidentally, as illustrated in FIG. 7 and FIG. 8, an absolute value of the parallel limiting value W(p) is equal to or more than an absolute value of the series limiting value W(s). The reason is as follows. When the operation mode of the electrical power converter 33 is the parallel mode, the electrical power converter 33 has the chopper circuit for the first electrical source 31 and the chopper circuit for the second electrical source 32, separately and independently. Thus, the ECU 40 is capable of controlling the electrical power converter 33 such that the electrical power distribution ratio r(0) becomes an appropriate distribution ratio. Therefore, the ECU 40 is capable of controlling the electrical power distribution ratio r(0) such that (i) the first electrical power P(1) is within the allowable value of the electrical power limiting value (a first electrical power limiting value) W(1) of the first electrical source 31 and (ii) the second electrical power P(2) is within the allowable value of the electrical power limiting value (a second electrical power limiting value) W(2) of the second electrical source 32. On the other hand, when the operation mode of the electrical power converter 33 is the series mode, the electrical power converter 33 has a single chopper circuit for both of the first electrical source 31 and the second electrical source 32. Thus, the ECU 40 is not capable of controlling the electrical power converter 33 such that the electrical power distribution ratio r(0) becomes the appropriate distribution ratio. However, even if the ECU 40 is not capable of controlling the electrical power distribution ratio r(0), the first electrical power P(1) needs to be within the allowable value of the first electrical power limiting value W(1) and the second electrical power P(2) needs to be within the allowable value of the second electrical power limiting value W(2). Thus, when the ECU 40 is not capable of controlling the electrical power distribution ratio r(0), it is preferable that the system electrical power P(0) itself be decreased and thus the first electrical power P(1) and the second electrical power P(2) be decreased, in order to allow the first electrical power P(1) to be within the allowable value of the first electrical power limiting value W(1) and the second electrical power P(2) to be within the allowable value of the second electrical power limiting value W(2). The decrease of the system electrical power P(0) can be realized by setting a relatively strict value (typically, a value whose absolute value is relatively small) to the system limiting value W(0). As a result, the absolute value of the series limiting value W(s) is equal to or less than the absolute value of the parallel limiting value W(p). Namely, the absolute value of the parallel limiting value W(p) is equal to or more than the absolute value of the series limiting value W(s).

As described above, the ECU 40 of the present embodiment is capable of appropriately changing the operation mode of the electrical power converter 33. Especially, the ECU 40 of the present embodiment is capable of preventing an over charge or an over discharge of the first electrical source 31 and the second electrical source 32 when the operation mode of the electrical power converter 33 is changed from the parallel mode to the series mode. Its technical reason will be explained below.

As described above, the absolute value of the series limiting value W(s) is typically equal to or less than the absolute value of the parallel limiting value W(p). In this case, if the operation mode of the electrical power converter 33 is changed from the parallel mode to the series mode before the system limiting value W(0) is changed to the series limiting value W(s), the over charge or the over discharge of at least one of the first electrical source 31 and the second electrical source 32 may arise. The over charge or the over discharge may cause a deterioration of at least one of the first electrical source 31 and the second electrical source 32 and a variation of an output of the motor generator 10.

For example, an example in which the first electrical power limiting value W(1), which is the upper limit value of the electrical power which can be inputted to the first electrical source 31, is 20 kW, the electrical voltage V(1) of the first electrical source 31 is 10 kV, the second electrical power limiting value W(2), which is the upper limit value of the electrical power which can be inputted to the second electrical source 32, is 10 kW and the electrical voltage V(2) of the second electrical source 31 is 10 kV will be explained. Furthermore, in this example, the parallel limiting value W(p) is 30 kW (=the sum of the first limiting value W(1) and the second limiting value W(2)) and series limiting value W(s) is 20 kW (<the parallel limiting value W(p).

In this example, when the operation mode of the electrical power converter 33 is the parallel mode, the ECU 40 is capable of controlling the electrical power converter 33 such that the electrical power distribution ratio r(0) becomes the appropriate distribution ratio. Therefore, the ECU 40 is capable of controlling the electrical power converter 33 such that the electrical power of 20 kW which is equal to or less than the first electrical power limiting value W(1) is inputted to the first electrical source 31 and the electrical power of 10 kW which is equal to or less than the second electrical power limiting value W(2) is inputted to the second electrical source 32.

Then, if the operation mode of the electrical power converter 33 is changed from the parallel mode to the series mode before the system limiting value W(0) is changed to the series limiting value W(s) under the above described condition, the electrical power distribution ratio r(0) becomes 1 1=10 kV 10 kV which is a ratio of the electrical voltage V(1) of the first electrical source 31 and the electrical voltage V(2) of the second electrical source 32. Thus, the electrical power of 15 kW is inputted to each of the first electrical source 31 and the second electrical source 32. Therefore, if only the operation mode of the electrical power converter 33 is changed from the parallel mode to the series mode, the over charge of the second electrical source 32 likely arise.

However, in the present embodiment, the system limiting value W(0) is changed to the series limiting value W(s)=20 kW before the operation mode of the electrical power converter 33 is changed from the parallel mode to the series mode. As a result, the system electrical power P(0) changes from 30 kW to 20 kW before the operation mode of the electrical power converter 33 is changed from the parallel mode to the series mode. After that, the operation mode of the electrical power converter 33 is changed from the parallel mode to the series mode. As a result, the electrical power of 10 kW is inputted to each of the first electrical source 31 and the second electrical source 32, because the electrical power distribution ratio r(0) becomes 1:1=10 kV:10 kV which is a ratio of the electrical voltage V(1) of the first electrical source 31 and the electrical voltage V(2) of the second electrical source 32. Therefore, the over charge of the second electrical source 32 does not arise.

Incidentally, the above described example focuses on the electrical power which is inputted to each of the first electrical source 31 and the second electrical source 32. However, same argument can be applied to the electrical power which is outputted from each of the first electrical source 31 and the second electrical source 32.

As described above, in the present embodiment, the ECU 40 is capable of changing the system limiting value W(0) to the series limiting value W(s) before changing the operation mode of the electrical power converter 33 from the parallel mode to the series mode. As a result, the system electrical power P(0) is within the allowable range of the series limiting value W(s) before the operation mode of the electrical power converter 33 is changed from the parallel mode to the series mode. Thus, the over charge or the over discharge of the first electrical source 31 and the second electrical source 32 does not likely arise, when the operation mode of the electrical power converter 33 is changed from the parallel mode to the series mode after the change of the system limiting value W(0). As described above, the ECU 40 of the present embodiment is capable of appropriately changing the operation mode of the electrical power converter 33.

In addition, the ECU 40 is capable of controlling the electrical power converter 33 such that the electrical power distribution ratio r(0) becomes the series distribution ratio r(s) before changing the system limiting value W(0) to the series limiting value W(s). Here, as described above, the absolute value of the series limiting value W(s) is typically equal to or less than the absolute value of the parallel limiting value W(p). Thus, the ECU 40 is capable of controlling the electrical power distribution ratio r(0) before the series limiting value W(s) which is relatively strict is used as the system limiting value W(0). Namely, the ECU 40 is capable of controlling the electrical power distribution ratio r(0) while the parallel limiting value W(p) which is not relatively strict is used as the system limiting value W(0). Therefore, the ECU 40 is capable of controlling the electrical power distribution ratio r(0) under the non-strict condition.

In addition, the ECU 40 is capable of controlling the electrical power converter 33 such that the electrical power distribution ratio r(0) becomes the series distribution ratio r(s) before the operation mode of the electrical power converter 33 is changed from the parallel mode to the series mode. Here, as described above, the electrical power distribution ratio r(0) is fixed to the series distribution ratio r(s)=V(1) V(2), when the operation mode of the electrical power converter 33 is the series mode. Thus, at least one of the first electrical power P(1) and the second electrical power P(2) may significantly vary, if the electrical power distribution ratio r(0) is not controlled before the operation mode of the electrical power converter 33 is changed from the parallel mode to the series mode. However, in the present embodiment, the variation of at least one of the first electrical power P(1) and the second electrical power P(2) is appropriately prevented, because, the electrical power distribution ratio r(0) is controlled before the operation mode of the electrical power converter 33 is changed from the parallel mode to the series mode.

In addition, the ECU 40 changes the system limiting value W(0) to the parallel limiting value W(p) after changing the operation mode of the electrical power converter 33 from the series mode to the parallel mode, when the operation mode of the electrical power converter 33 is changed from the series mode to the parallel mode. Thus, the ECU 40 is capable of preventing the over charge or the over discharge of the first electrical source 31 and the second electrical source 32 even when the operation mode of the electrical power converter 33 is changed from the series mode to the parallel mode. Its technical reason will be explained below.

As described above, the absolute value of the series limiting value W(s) is typically equal to or less than the absolute value of the parallel limiting value W(p). Therefore, the system electrical power P(0) may increase when the system limiting value W(0) is changed from the series limiting value W(s) to the parallel limiting value W(p). In this case, if the system limiting value W(0) is changed to the parallel limiting value W(p) before the operation mode of the electrical power converter 33 is changed from the series mode to the parallel mode, the system electrical power P(0) may not within the allowable range of the series limiting value W(s) which is stricter than the parallel limiting value W(p) even when the operation mode of the electrical power converter remains in the series mode. As a result, the first electrical power P(1) may not be within the allowable range of the first electrical power limiting value W(1) or the second electrical power P(2) may not be within the allowable range of the second electrical power limiting value W(2). Therefore, the over charge or the over discharge of at least one of the first electrical source 31 and the second electrical source 32 may arise in some cases. However, in the present embodiment, the system limiting value W(0) is changed to the parallel limiting value W(p) after the operation mode of the electrical power converter 33 is changed from the series mode to the parallel mode. Thus, the over charge or the over discharge of the first electrical source 31 and the second electrical source 32 does not likely arise, even when the operation mode of the electrical power converter 33 is changed from the series mode to the parallel mode.

In addition, the ECU 40 is capable of controlling the electrical power converter 33 such that the electrical power distribution ratio r(0) becomes the parallel distribution ratio r(p) after the system limiting value W(0) is changed to the parallel limiting value W(p). Here, as described above, the absolute value of the series limiting value W(s) is typically equal to or less than the absolute value of the parallel limiting value W(p). Thus, the ECU 40 is capable of controlling the electrical power distribution ratio r(0) before not the series limiting value W(s) which is relatively strict but the parallel limiting value W(p) which is not relatively strict is used as the system limiting value W(0). Therefore, the ECU 40 is capable of controlling the electrical power distribution ratio r(0) under the non-strict condition.

Incidentally, in the above described explanation, the ECU 40 changes the system limiting value W(0) to the series limiting value W(s) after controlling the electrical power converter 33 such that the electrical power distribution ratio r(0) becomes the series distribution ratio r(s) (see step S21 to step S22 in FIG. 6), when the operation mode of the electrical power converter 33 is changed from the parallel mode to the series mode. However, the ECU 40 may controls the electrical power converter 33 such that the electrical power distribution ratio r(0) becomes the series distribution ratio r(s) after changing the system limiting value W(0) to the series limiting value W(s). Even in each case, a first control to allow the electrical power distribution ratio r(0) to become the series distribution ratio r(s) and a second control to allow the system electrical power P(0) to be within the allowable range of the series limiting value W(s) are performed separately. Considering that a controlling target value of the first control and a controlling target value of the second control are typically different from each other, a processing load of the ECU 40 is reduced, compared to the case where the first and second control are performed simultaneously. However, the ECU 40 may change the system limiting value W(0) to the series limiting value W(s) while controlling the electrical power converter 33 such that the electrical power distribution ratio r(0) becomes the series distribution ratio r(s).

Moreover, in the above described explanation, the ECU 40 controls the electrical power converter 33 such that the electrical power distribution ratio r(0) becomes the parallel distribution ratio r(p) after changing the system limiting value W(0) to the parallel limiting value W(p) (see step S32 to step S33 in FIG. 6), when the operation mode of the electrical power converter 33 is changed from the series mode to the parallel mode. However, the ECU 40 may change the system limiting value W(0) to the parallel limiting value W(p) after controlling the electrical power converter 33 such that the electrical power distribution ratio r(0) becomes the parallel distribution ratio r(p). Even in this case, the processing load of the ECU 40 is also reduced, compared to the case where a control to allow the electrical power distribution ratio r(0) to become the parallel distribution ratio r(p) and a control to allow the system electrical power P(0) to be within the allowable range of the parallel limiting value W(p) are performed simultaneously. However, the ECU 40 may change the system limiting value W(0) to the parallel limiting value W(p) while controlling the electrical power converter 33 such that the electrical power distribution ratio r(0) becomes the parallel distribution ratio r(p).

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention. An electrical power converter, which involve such changes, are also intended to be within the technical scope of the present invention.

### REFERENCE SIGNS LIST

1 vehicle
30 electrical source system
31 first electrical source
32 second electrical source
33 electrical power converter
40 ECU
C smoothing capacitor
L1, L2 reactor
P(0) system electrical power
P(1) first electrical power
P(2) second electrical power
r(0) electrical power distribution ratio
r(s) series distribution ratio
W(0) system limiting value
W(s) series limiting value
V(1) electrical voltage of first electrical source
V(2) electrical voltage of second electrical source
S1, S2, S3, S4 switching element

1. An electrical source control apparatus which is configured to control an electrical source system,
the electrical source system comprising: (i) a plurality of electricity storage apparatuses; and (ii) an electrical power converter,
the electrical power converter being configured to perform an electrical power conversion among the plurality of electricity storage apparatuses and an electrical source wire which is electrically connected to a load, the electrical power converter being capable of changing an operation mode of the electrical power converter between a first mode and a second mode, wherein the first mode is an operation mode in which the electrical power converter performs the electrical power conversion with the plurality of electricity storage apparatuses being electrically connected in series to the electrical source wire and the second mode is an operation mode in which the electrical power converter performs the electrical power conversion with the plurality of electricity storage apparatuses being electrically connected in parallel to the electrical source wire,
the electrical source control apparatus comprising a controller,
the controller being programmed to:
change an electrical power limiting value from a second limiting value to a first limiting value, wherein the electrical power limiting value represents at least one of an allowable value of an electrical power which can be inputted to the electrical source system and an allowable value of an electrical power which can be outputted from the electrical source system, the first limiting value is an limiting value which is to be set when the electrical power converter operates in the first mode, and the second limiting value is an limiting value which is to be set when the electrical power converter operates in the second mode; and
change the operation mode of the electrical power converter from the second mode to the first mode after the controller changes the electrical power limiting value from the second limiting value to the first limiting value.

2. The electrical source control apparatus according to claim 1, wherein
the controller is programmed to change the operation mode of the electrical power converter from the second mode to the first mode, when an actual electrical power which is actually inputted to or actually outputted from the electrical source system is within an allowable range of the first limiting value after the controller changes the electrical power limiting value from the second limiting value to the first limiting value.

3. The electrical source control apparatus according to claim 1, wherein the controller is programmed to determine whether or not the operation mode of the electrical power converter is to be changed, wherein
the controller is programmed to change the electrical power limiting value from the second limiting value to the first limiting value when the controller determines that the operation mode of the electrical power converter is to be changed from the second mode to the first mode.

4. The electrical source control apparatus according to claim 1, wherein the controller is programmed to control an electrical power distribution ratio between the plurality of electricity storage apparatuses, wherein
the controller is programmed to change the electrical power limiting value from the second limiting value to the first limiting value after the controller controls the electrical power distribution ratio such that the electrical power distribution ratio becomes a first distribution ratio which is to be set when the electrical power converter operates in the first mode.

5. The electrical source control apparatus according to claim 1, wherein
the controller is programmed to further change the operation mode of the electrical power converter from the first mode to the second mode,
the controller is programmed to change the electrical power limiting value from the first limiting value to the second limiting value after the control changes the operation mode of the electrical power converter from the first mode to the second mode.

6. The electrical source control apparatus according to claim 5, wherein the control is programmed to determine whether or not the operation mode of the electrical power converter is to be changed, wherein
the controller is programmed to change the operation mode of the electrical power converter from the first mode to the second mode when the control determines that the operation mode of the electrical power converter is to be changed from the first mode to the second mode.

7. The electrical source control apparatus according to claim 5, wherein the control is programmed to control an electrical power distribution ratio between the plurality of electricity storage apparatuses, wherein
the controller is programmed to control the electrical power distribution ratio such that the electrical power distribution ratio becomes a second distribution ratio which is to be set when the electrical power converter operates in the second mode after the contoller changes the electrical power limiting value from the first limiting value to the second limiting value.
